(19) United States
(12) Patent Application Publication
(10) Pub. No.: US 2009/0095729 A1
(43) Pub. Date: Apr. 16, 2009

(54) DOMESTIC EQUIPMENT GROUPING

(75) Inventors: James DYSON, Malmesbury (GB); Peter David Gammack, Malmesbury (GB); David Campbell, Malmesbury (GB)

Correspondence Address: MORRISON & FOERSTER LLP, 1650 TYSONS BOULEVARD, SUITE 400, MCLEAN, VA, 22102, US

(73) Assignee: Dyson Technology Limited, Malmesbury (GB)

(21) Appl. No.: 12/242,391

(22) Filed: Sep. 30, 2008

(30) Foreign Application Priority Data
Oct. 16, 2007 (GB) 0720132.0

(51) Int. Cl. F24C 7/10; F27D 11/00

(52) U.S. Cl. 219/386; 219/428

(57) ABSTRACT

A domestic equipment group includes a plurality of free standing domestic electrical appliances, at least two of which are for the preparation of foodstuffs. Each appliance has a different respective function and comprises an outer housing generally in the shape of a cuboid having two side surfaces and flat upper, front, and rear surfaces each extending between the side surfaces. The housings are substantially of equal height and equal depth, which enables the appliances to be juxtaposed on a work counter or a shelf, either with contiguous side surfaces or with contiguous rear surfaces, with no wasted space between the appliances. The flat surfaces of the appliances enables the exposed surfaces of the housings to be quickly and easily wiped clean.

### REFERENCE TO RELATED APPLICATIONS

This application claims the priority of United Kingdom Application No. 0720132.0, filed Oct. 16, 2007, the contents of which are incorporated herein by reference.

### FIELD OF THE INVENTION

The invention relates to domestic equipment. Particularly, but not exclusively, the invention relates to domestic equipment comprising a plurality of worktop, or free standing, domestic electrical appliances for the preparation of foodstuffs.

### BACKGROUND OF THE INVENTION

Domestic electrical appliances for the preparation of foodstuffs, which term includes both food and drink, have a wide range of different shapes and sizes. Although common colours, materials and/or styling features may be applied to appliances by manufacturers in order to distinguish their appliances from those of other manufacturers, each appliance tends to have a conventional shape. For example, kettles are traditionally in the form of either a jug or a dome, having a lid, a handle for lifting the kettle, and a spout from which hot water is poured from the kettle. Toasters, on the other hand, are traditionally in the form of a box having a curved upper surface in which slots are located for inserting bread slices into the toasting chambers, and side surfaces accommodating control features such as a timer and a bread ejector.

A user will generally leave the more frequently operated appliances, such as toasters and kettles, on a work counter when they are not in use so as to avoid the inconvenience of storing these appliances between uses. Due to their various different shapes and sizes, these appliances can not be closely packed together on the counter, resulting in an amount of wasted counter space between the appliances which can not be used for other purposes, such as food preparation. It is also common practice to leave a “footprint” around each appliance so that handles and control features can be readily accessed, which can further reduce the amount of usable counter space.

Any appliances which are left on a counter will require regular cleaning. The traditional shapes of appliances such as kettles, food processors and beverage makers mean that these appliances tend to have a relatively large external surface area upon which dirt and grease can accumulate, which in turn increases the time required to wipe clean the external surfaces of these appliances. Appliances such as food processors and beverage makers also tend to have relatively complex external shapes, increasing further the time required to clean those appliances.

Although a user will tend to store the less frequently operated appliances when not in use, the various different shapes and sizes of the appliances can significantly reduce storage efficiency. For example, the appliances may not be able to be closely packed on a shelf or in a cupboard, leaving unused storage space around the appliances.

### SUMMARY OF THE INVENTION

It is an aim of this invention to seek to solve these prior art problems and other problems.

The present invention provides domestic equipment comprising a plurality of free standing domestic electrical appliances, at least two of said appliances being for the preparation of foodstuffs, each appliance having a different respective function and comprising an outer housing generally in the shape of a cuboid having two side surfaces and flat upper, front, and rear surfaces each extending between the side surfaces, the housings being substantially of equal height and equal depth.

Shaping the outer housings of the appliances in this manner enables the appliances to be juxtaposed on a work counter with contiguous side surfaces and with no wasted counter space between the appliances. The appliances may be so positioned against a wall or other flat vertical surface so that there is no wasted counter space behind the appliances, or centrally on a kitchen island to provide usable counter space both in front of and behind the appliances.

The shape of the outer housings also enables the appliances to be juxtaposed on a horizontal work counter, or other support surface, with substantially flush and co-planar upper surfaces, and substantially flush and co-planar front surfaces. Having surfaces devoid of features within which dirt or grease can accumulate enables the upper, front and rear surfaces of the housings to be quickly and easily wiped clean.

The flat surfaces of the housings enable the appliances to be arranged in a variety of different configurations. With flat side surfaces, the appliances can be arranged in a row with substantially flush front and upper surfaces. The flat upper surfaces enable the appliances to be stacked in a column with substantially flush front and rear surfaces, and the flat rear surfaces allow the appliances to be juxtaposed in a back-to-back arrangement with substantially flush upper surfaces. Consequently, the appliances can be used or stored, for example, on a work counter, on a shelf, in a drawer, in a cupboard or on a carriage of a kitchen unit, in a configuration which makes optimum use of the available space. At least two of the appliances may have housings substantially of the same width, allowing the appliances to be stacked in a column, or juxtaposed back-to-back, with substantially flush and co-planar side surfaces to facilitate storage and cleaning.

Although the edges between adjoining surfaces of each housing may be chamfered to prevent injury to a user rubbing against an exposed edge of an appliance, it is preferred that the radius of each chamfer is less than 20 mm, more preferably less than 10 mm and even more preferably less than 5 mm, to minimise the size of any groove formed between the flush surfaces of the housings when the appliances are juxtaposed, and within which dirt may accumulate. In one embodiment the radius of each chamber is in the range from 0.5 to 5 mm.

Each housing may comprise a control panel for controlling the operation of the appliance. The control panel may comprise a touch-sensitive screen and/or a plurality of buttons. The control panel is preferably located in a recessed portion of the upper surface of the housing so that the upper surface of the control panel is substantially flush with the upper surface of the housing.

The control panel is preferably located towards the front surface of the housing, and is preferably oriented so that, when the appliances are positioned alongside one another with substantially flush front surfaces, the control panels of the appliances are aligned. In addition to providing the appliances with a uniform appearance, this enables a row of appliances to be located partially beneath a second row of appliances, or partially beneath a shelf, cupboard or other item, without obscuring the control panels of the appliances.

Each appliance preferably comprises a base, which may be either integral with the housing or attached to the lower surface of the housing. In the preferred embodiment the base comprises a plate attached to the lower surface of the housing and having a thickness no greater than 20 mm, more preferably no greater than 10 mm. The plate may be rectangular, and may have a peripheral surface which is substantially flush with adjoining surfaces of the housing. Alternatively, the peripheral surface of the base may be located wholly within the foot-print of the housing.

The appliances may be connected together in a row so that the front surfaces of the housings are substantially flush. This can prevent an appliance from becoming displaced from its alignment with an adjacent appliance, for example during cleaning or use, or accidentally.

Each appliance preferably comprises a connector for connecting that appliance to one of the other appliances so that the front surfaces of the housings of those appliances are substantially flush. The connector is preferably carried by the base so as not to disrupt the flat surfaces of the housing. The connector is preferably moveable relative to the base between a stowed position in which it does not protrude beyond the base, and a deployed position in which it is connectable to the base of another appliance. In the preferred embodiment the connector is pivotably moveable relative to the base, but alternatively it may be transversely moveable relative to the base. A manually-operable catch or other retaining element may be provided for retaining the connector in the stowed position.

The appliance preferably comprises a retainer for retaining a deployed connector of another appliance so that, when a deployed connector of one of the appliances is retained therein, the front surfaces of those two appliances are substantially flush. In the preferred embodiment the retainer comprises a profiled portion of the base shaped to receive a deployed connector of another appliance.

The base may be configured to receive and store a mains cable extending from the lower surface of the housing. In the preferred embodiment the lower surface of the base is shaped to define a channel for receiving and storing the cable. The channel preferably comprises at least one opening located on the peripheral surface of the base and through which the cable may extend from the base when the appliance is located in an upright position on a work surface, a first portion for retaining a length of the cable, and a second portion for guiding the cable from the first portion to the opening. The first portion preferably extends about a hub around which the cable may be wound, and preferably comprises a plurality of catches for holding the wound cable. This enables a chosen length of cable to be stored within the base to optimise the length of cable extending from the opening.

The channel preferably comprises a plurality of openings located about the periphery of the base, with the second portion of the channel being shaped to guide the cable to a selected one of the openings. This permits the cable to extend from the appliance in one of a number of different directions.

These openings are preferably located about the bases of the appliances so that, when the appliances are juxtaposed with contiguous side surfaces on a horizontal support surface with substantially flush front surfaces, an opening of the base of one of the appliances is aligned with an opening of the base of one of the other appliances. In the preferred embodiment, a first opening is located on a first side of the base, and a second opening is located on a second side of the base opposite the first side, and preferably substantially opposite the first opening. A third opening may be located on a third side of the base which extends between the first and second openings, and which is located adjacent the rear surface of the housing. The third opening is preferably located mid-way between the first and second sides of the base, so that when two appliances are juxtaposed with contiguous rear surfaces on a horizontal support surface with substantially flush side surfaces, an opening of the base of one of the appliances is aligned with an opening of the base of the other appliance.

At least the second portion of the channel and the openings are preferably shaped to enable part of a mains cable of another electrical appliance to be located within the channel. A cable from one appliance may therefore pass through the aligned openings of a number of juxtaposed appliances before extending out from an opening in the base of one of the other appliances, together with at least one other mains cable, thereby significantly reducing the length of cable exposed on a surface on which the appliances are located.

The appliances are preferably portable to enable the appliances to be positioned in any desired location on a counter or other work surface, and to be stored in a shelf, cupboard or the like. Alternatively, the appliances may be fixed to a work counter, for example in a recessed portion of the counter so that only part of the appliances protrudes above the surface of the counter.

At least one of the appliances may have a function which is other than for the preparation of foodstuffs. Examples of such an appliance include an audio/visual appliance, such as a television, a display screen, a radio, a DVD player or a CD player, a clock, a loudspeaker, a steriliser, or a drinks cooler. This appliance may be conveniently juxtaposed between two of the appliances for the preparation of foodstuffs, or on the end of a row of such appliances, without any wasted counter space between the adjoining appliances and without disrupting the flush upper and front surfaces of the appliances.

The expression “preparation of foodstuffs” as used here includes dispensation, processing, heating and cooking of food and/or drink. Appliances for the preparation of foodstuffs preferably comprise two or more of a juice extractor, a toaster, a beverage maker, a hot water dispenser, a kettle, and a coffee grinder.

A water tank may be provided for supplying water to at least one of these appliances, for example to one or more of a kettle, a coffee maker and a water dispenser. The water tank preferably comprises an outer housing substantially of the same height and depth as the housings of the appliances. This enables the water tank to be juxtaposed with the appliances in a space-efficient manner so that, for example, the front and upper surfaces of the water tank are flush with the front and upper surfaces of the appliances.

### BRIEF DESCRIPTION OF THE DRAWINGS

Embodiments of the invention will now be described with reference to the accompanying drawings in which:

FIG. 1 is a perspective view of a first arrangement of domestic equipment according to the invention;

FIG. 2 is a plan view of the lower surface of the base of an appliance of the equipment of FIG. 1;

FIG. 3 is a perspective view of part of the lower surface of the base of FIG. 2, showing the connector in a stowed position;

FIG. 4 is a plan view of the lower surfaces of the bases of two connected appliances of the equipment of FIG. 1;

FIG. 5 is a plan view of the lower surfaces of the bases of two appliances of the equipment of FIG. 1 arranged back-to-back;

FIG. 6 is a perspective view of a second arrangement of domestic equipment according to the invention;

FIG. 7 is a perspective view of a third arrangement of domestic equipment according to the invention;

FIG. 8 is a perspective view of a fourth arrangement of domestic equipment according to the invention;

FIG. 9 is a perspective view of a cupboard storing domestic equipment according to the invention;

FIG. 10 is a perspective view of a fifth arrangement of domestic equipment according to the invention;

FIG. 11 is a front view of the arrangement of FIG. 10;

FIG. 12 is a rear view of the arrangement of FIG. 10; and

FIG. 13 is a plan view of the arrangement of FIG. 10.

### DETAILED DESCRIPTION OF THE INVENTION

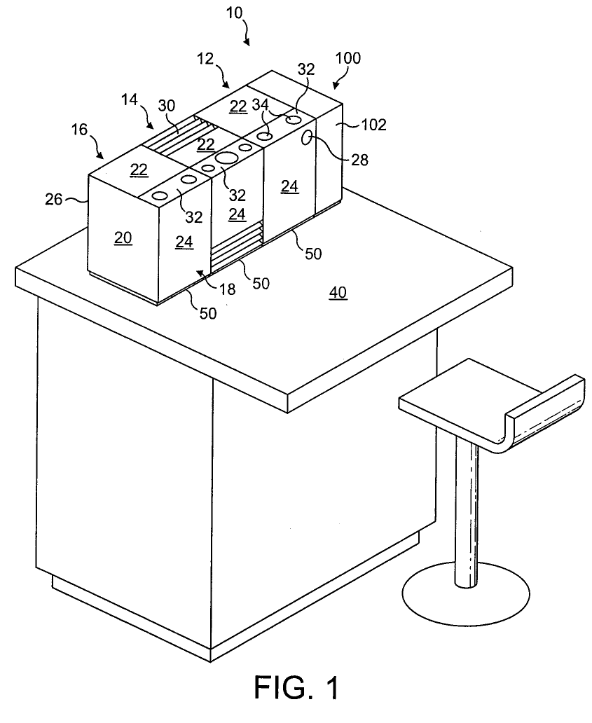

FIG. 1 illustrates an example of domestic equipment 10 according to the invention. The equipment 10 comprises a plurality of free standing, domestic electrical appliances. Although the equipment 10 may comprise any number of two or more appliances, in the illustrated example the equipment 10 comprises three appliances 12, 14, 16.

At least two of the appliances 12, 14, 16 are for the preparation of foodstuffs, and may comprise a respective one of a juice extractor, a toaster, a beverage maker, a hot water dispenser, a kettle, and a coffee grinder so that each appliance has a respective different function. In the example illustrated in FIG. 1, the first appliance 12 is a beverage dispenser and the second appliance 14 is a toaster. The third appliance 16 may also be for the preparation of foodstuffs. Alternatively, the third appliance may have a function other than the preparation of foodstuffs. For example, the third appliance 16 may be one of an audio/visual appliance, such as a television, a display screen, a radio, a DVD player or a CD player, a clock, a loudspeaker, a steriliser, and drinks cooler. In the example illustrated in FIG. 1, the third appliance 16 is a radio.

Each of the appliances 12, 14, 16 comprises an outer housing 18. Each housing 18 has two side surfaces 20 and, extending between the side surfaces 20, an upper surface 22, a front surface 24, a rear surface 26 and a lower surface (not shown). At least one of the upper, front and rear surfaces 22, 24, 26 is preferably substantially flat. In this example, each of the upper, front and rear surfaces 22, 24, 26 is substantially flat, with each housing 18 being generally in the shape of cuboid, or right parallelepiped. Although the edges between adjoining surfaces of each housing 18 may be chamfered, it is preferred that the radius of each chamfer is less than 10 mm, preferably in the range from 0.5 to 5 mm. In this embodiment, the radius of each chamfer is around 2 mm.

One or more of the surfaces of the housing 18 may comprise a door or a lid which is moveable between a closed position, in which it is flush with the remainder of that surface, and an open position in which a user may access internal components of the appliance. For example, the first appliance 12 may include a drawer slidably mounted in its front surface 24 for allowing a user to introduce ingredients to the first appliance 12, and the second appliance 14 may have a hinged front surface 24 for allowing a user to introduce products to be toasted to the second appliance 14. Alternatively, or additionally, part of the housing 18 may be shaped to define one or more apertures. In this example, the front surface 24 of the first appliance 12 includes an aperture 28 through which a retractable dispensing spout may selectively extend, and the upper surface 22 of the second appliance 14 includes an aperture 30 through which steam and/or heat may be emitted from the housing 18 during use. A series of holes may be formed in the front surface 24 of the third appliance 16 for emitting sound from that appliance 16.

A control panel 32 for controlling the operation of the appliance 12, 14, 16 is located in a recessed portion of the upper surface 22 of each housing 18. To maintain the flatness of the upper surface 22 of the housing 18, the control panel 32 is sized and shaped to fit in the recessed portion of the upper surface 22 so the upper surface of the control panel 32 is substantially flush with the upper surface 22 of the housing 18. In this example, each control panel 32 comprises a plurality of user operable buttons 34 for controlling the operation of the appliance 12, 14, 16. Alternatively, or additionally, the control panel 32 may comprise a touch-sensitive screen providing a user interface for controlling operation of the appliance 12, 14, 16.

The housings 18 of the appliances 12, 14, 16 are substantially of the same height and same depth. The height of the appliances 12, 14, 16 is preferably in the range from 250 to 300 mm, and the depth of the appliances 12, 14, 16 is preferably in the range from 170 to 230 mm. In this example, the appliances 12, 14, 16 are substantially of the same width, which is preferably in the range from 120 to 180 mm. However, one or more of the appliances 12, 14, 16 may have a different width than the others. For example, the third appliance 16 may be narrower than both the first appliance 12 and the second appliance 14.

As illustrated in FIG. 1, shaping the housings 18 of the appliances 12, 14, 16 in this manner enables the equipment 10 to be arranged in a row on a work counter 40 with contiguous side surfaces 20 and with no wasted counter space between, in front of or behind the appliances 12, 14, 16. The common shape of the housings 18 also enables the appliances 12, 14, 16 to be arranged in a row on a work counter 40 with not only substantially flush upper surfaces 22, but also with substantially flush front surfaces 24, allowing a user to quickly and easily wipe clean these surfaces.

The appliances 12, 14, 16 may be connected together in the configuration illustrated in FIG. 1 to prevent one of the appliances from becoming displaced from its alignment with the other appliances, for example during cleaning or use, or accidentally. The appliances 12, 14, 16 may be connected together in one of a number of different ways. For example magnets may be used to connect the side surface 20 of one appliance to an opposing side surface 20 of another appliance. Alternatively, the side surfaces 20 of the housings 18 may be formed or otherwise provided with complementary interlocking features.

In this example, each appliance 12, 14, 16 comprises a base 50 carrying a connector for connecting that appliance to one of the other appliances so that, when those appliances have been connected together, the upper, front and rear surfaces 22, 24, 26 of the housings 18 of those appliances are respectively co-planar. Each base 50 is in the form of a rectangular plate connected to the lower surface of the housing 18, and having a thickness of no greater than 20 mm, more preferably no greater than 10 mm. In this example, the base 50 has a thickness of around 8 mm. The base 50 is preferably shaped so that when it is connected to the housing 18, the long side surfaces 51a, 51b of the base 50 are each substantially flush with a respective side surface 20 of the housing 18, short side surface 51c of the base 50 is substantially flush with the rear surface 26 of the housing 18, and short side surface 51d of the base 50 is substantially flush with the front surface 24 of the housing 18.

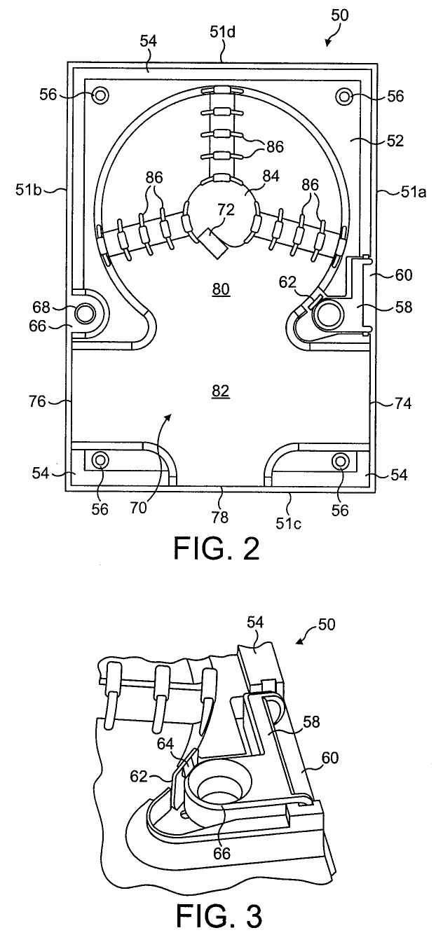

FIG. 2 illustrates the lower surface 52 of the base 50 of each appliance 12, 14, 16. The lower surface 52 is shaped to have a raised periphery 54 for contacting the surface, for example counter 40, upon which the appliance 12, 14, 16 is placed. Female connectors 56 may be provided towards the comers of the lower surface 52 for receiving optional feet (not shown) for contacting the counter 40, for example if the counter 40 is uneven and the appliance 12, 14, 16 would otherwise undesirably rock if placed on that surface. The feet may be screwed into the female connectors 56 to provide the user with the ability to adjust the relative positions of the feet, through rotation thereof, so that the upper surface 22 of the housing 18 is substantially horizontal when the appliance is located on the counter 40. The feet preferably have a height of no more than 5 mm so that the periphery 54 of the base 50 is only slightly raised above the surface of the counter 40 by the feet.

A connector 58 for connecting the base 50 to the base of an adjacent appliance is located towards the long side surface 51a of the base 50. While in this example the connector 58 is d-shaped, the connector 58 may take any one of a number of different shapes. The connector 58 is moveable between a stowed position in which it does not protrude beyond the base 50, and a deployed position in which it is connectable to an adjacent appliance. FIGS. 2 and 3 illustrate the connector 58 in its stowed position, in which the connector 58 is located within a first recessed portion 60 of the lower surface 52 of the base 50 so that the connector 58 does not protrude either above the raised periphery 54 or beyond the side surface 51a of the base 50. A retaining member 62 integrally formed with the base 50 has a lug 64 for releasably retaining the connector 58 in its stowed position.

In this example, the connector 58 is connected to the base 50 so that it is pivotably moveable about an axis extending substantially parallel to, and displaced inwardly from, the side surface 51a of the base 50. To release the connector 58 from its stowed position, a user presses against the lug 64 of the retaining member 62 with one finger to move it away from the connector 58. Simultaneously, using another finger hooked beneath a profiled rim 66 of the connector 58 the user rotates the connector 58 clockwise about the axis to move the connector 58 out from the first recessed portion 60 of the base 50. In this example, the connector 58 is rotated clockwise through approximately 180° to move it from its stowed position to its fully deployed position.

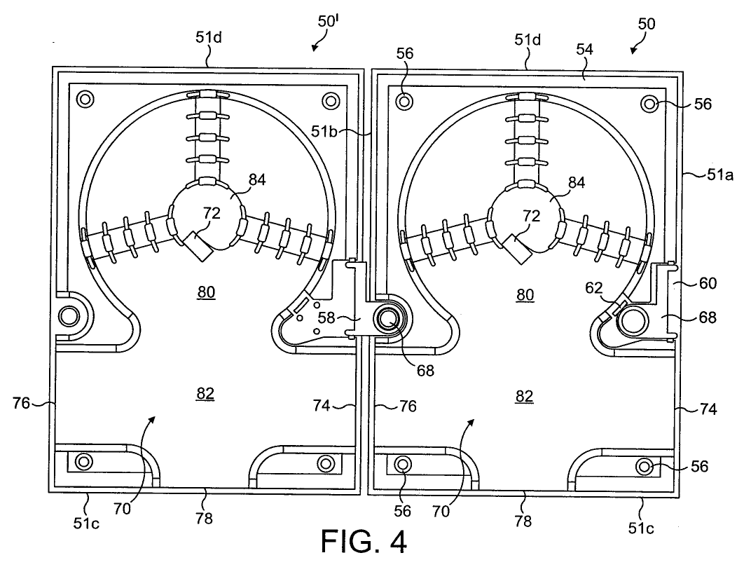

The base 50 is also shaped to retain a deployed connector 58 of the base 50′ of an adjacent appliance, as illustrated in FIG. 4. In this example the base 50 has a second recessed portion 66 located towards the other long side surface 51b of the base 50 for receiving a deployed connector 58 of another appliance. The second recessed portion 66 includes a centrally located protrusion 68 about which the connector 58 of the adjacent appliance is locatable, and which preferably forms an interference fit with the connector 58 to releasably retain the connector 58 in its deployed position. The second recessed portion 66 is positioned on the base 50 so that, as mentioned above, when two of the appliances 12, 14, 16 have been connected together the upper, front and rear surfaces 22, 24, 26 of the housings 18 of those appliances are substantially flush. When connected together, these two appliances preferably also have substantially parallel and contacting opposing side surfaces 20 so that there is substantially no gap between the appliances within which dirt and grease may accumulate.

Returning to FIG. 2, the lower surface 52 of the base 50 is further shaped to define a channel 70 for receiving and storing the mains cable (not shown) of the appliance 12, 14, 16. The mains cable extends from the lower surface of the housing 18 into the channel 70 through an aperture 72 located towards the centre of the base 50.

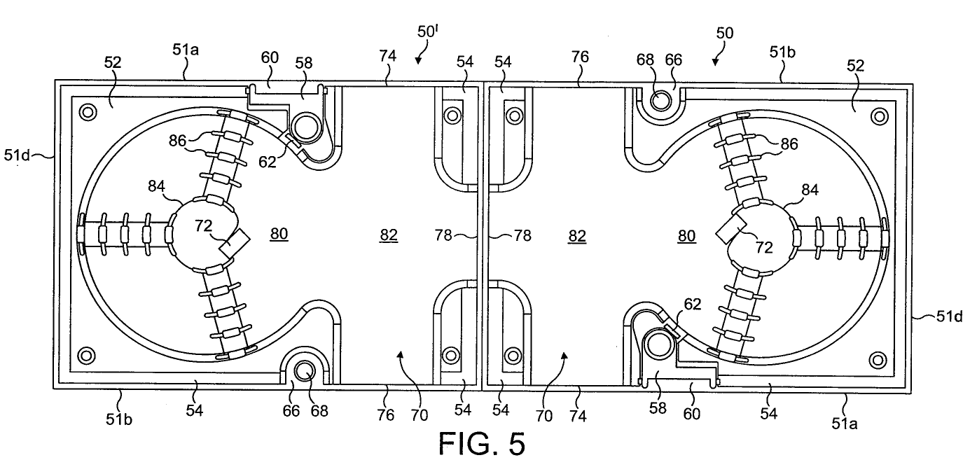

The channel 70 comprises a plurality of openings located about the periphery 54 of the lower surface 52 of the base 50 and through a selected one of which the mains cable may extend from the base 50 when the appliance 12, 14, 16 is located in an upright position on the work counter 40. The relatively small size of the optional feet discussed above prevents the mains cable from otherwise protruding from the base 50 between two of the openings. In this example a first opening 74 is located on long side surface 51a of the base and a second opening 76 is located on long side surface 51b of the base 50. As discussed in more detail below, the second opening 76 is located substantially opposite the first opening 74 so that when two appliances are connected together as illustrated in FIG. 4, the first opening 74 of base 50 is aligned with the second opening 76 of base 50′. A third opening 78 is located on short side surface 51c of the base 50, preferably mid-way between the long side surfaces 51a, 51b of the base 50 so that when two similar sized appliances are positioned back-to-back with flush side surfaces 20, the third openings 78 of the bases 50, 50′ of these two appliances are aligned, as illustrated in FIG. 5.

The channel 70 has a first portion 80 for retaining a length of the mains cable, and a second portion 82 for guiding the cable from the first portion 80 to a selected one of the openings 74, 76, 78. The first portion 80 of the channel 70 extends about a hub 84 located adjacent to the aperture 72 through which the main cable enters the channel 70, and about which a selected length of the cable may be wound. The base 50 may be formed with a number of sets of cooperating catches 86 for retaining the wound cable within the first portion 80 of the channel 70. In this example the second portion 82 of the channel 70 is substantially T-shaped to extend from the first portion 80 of the channel 70 to each of the three openings 74, 76, 78.

The openings 74, 76, 78 and the second portion 82 of the channel 70 are sized to enable part of a mains cable of another electrical appliance to be located within the channel 70. In this example, the openings 74, 76, 78 and the second portion 82 of the channel 70 are sized to enable the channel 70 to accommodate parts of at least three additional mains cables each extending from a respective appliance. For example, in the arrangements illustrated in FIGS. 4 and 5 in which the opening of one base is aligned with the opening of another base, the mains cables of the two appliances may be arranged within the channels 70 of the bases 50, 50′ so that both cables extend from the appliances through a common one of the openings 74, 76, 78 of base 50. This sizing of the channel 70 of each base permits the mains cables of a number of juxtaposed appliances to be arranged wholly beneath the appliances before extending from a single opening in the base of one of the appliances towards a bank of sockets.

Returning to FIG. 1, the equipment 10 may optionally include a water tank 100 for supplying water to at least one of the appliances, in this example the first appliance 12. The water tank 100 has an outer housing 102 substantially of the same height and depth as the housings 18 of the appliances 12, 14, 16. This enables the water tank 100 to be positioned alongside the appliances 12, 14, 16 so that it blends in seamlessly with the appliances 12, 14, 16, that is, with the front, upper and rear surfaces of the water tank 100 flush with the corresponding surfaces 22, 24, 26 of the appliances 12, 14, 16.

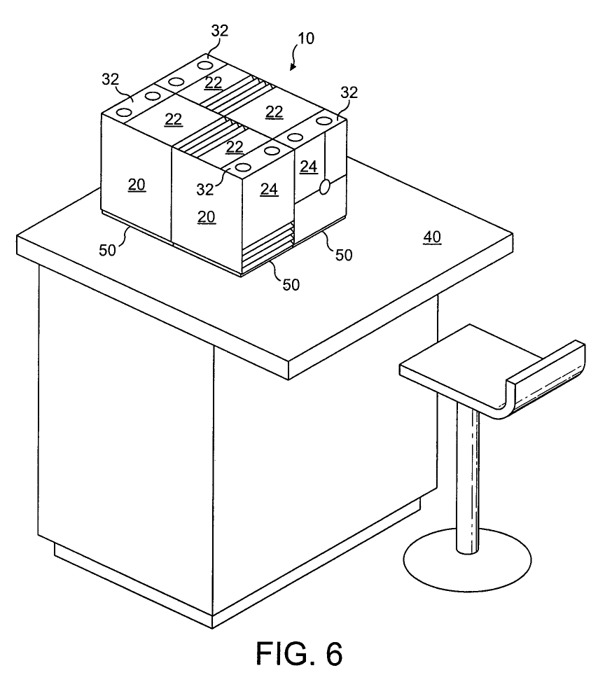

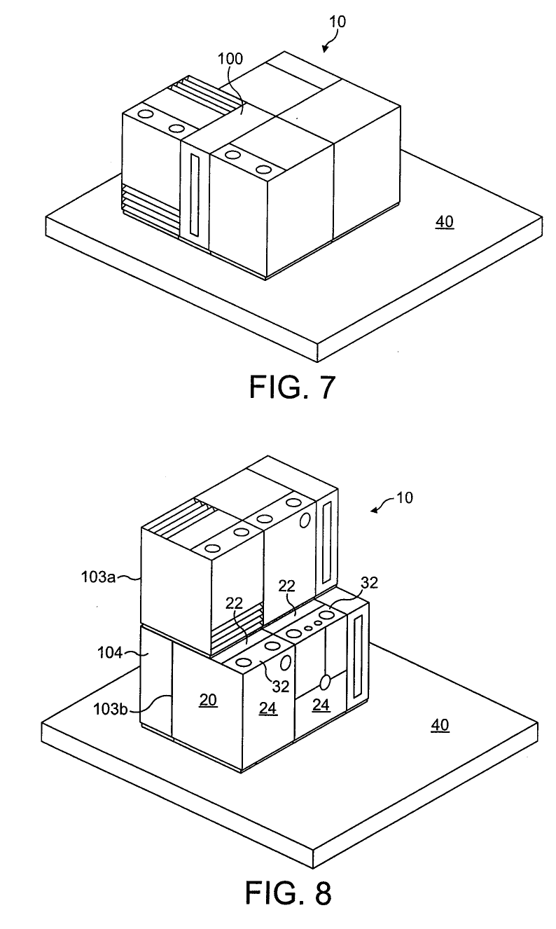

The appliances 12, 14, 16 are preferably portable so that they may be positioned at any desired location. The flat surfaces of the housings 18, 102 enable the equipment 10 to be positioned in a variety of different arrangements. As illustrated in FIG. 1, the flat side surfaces 20 allow the equipment 10 to be arranged in a row with substantially flush upper and front surfaces 22, 24. The flat rear surfaces 26 allow the equipment 10 to be juxtaposed in a back-to-back arrangement as illustrated in FIG. 6 with substantially flush upper surfaces 22. FIG. 7 illustrates a similar arrangement to that of FIG. 6 in which a water tank 100 is located between two of the appliances of the equipment 10, for example between a hot water dispenser and a beverage dispenser, for supplying water to both of these appliances. The flat upper surfaces 22 of the equipment 10 enable one appliance to be positioned at least partially on top of one of the other appliances. For example, FIG. 8 illustrates an arrangement in which one row 103a of appliances is located partially on top of another row 103b of appliances. A support member 104 is located behind the lower row 103b of appliances to support the upper row 103a of appliances. The control panel 32 of each appliance is preferably located towards the front of the upper surface 22 to enable a row 103a of appliances to be located partially beneath another row 103b of appliances, or partially beneath a shelf, cupboard or other item, without obscuring the control panels 32 of those appliances.

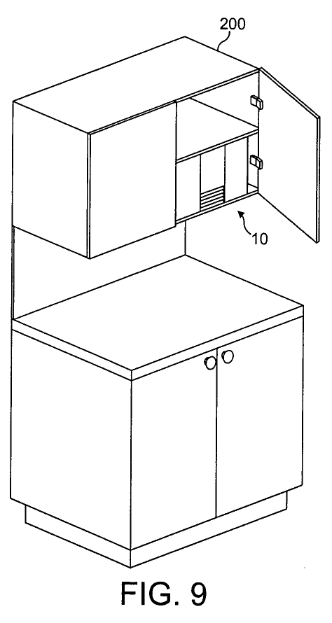

The shape of the equipment 10 also facilitates storage of the appliances when not in use. As illustrated in FIG. 9, the appliances may be arranged on a shelf of a wall cupboard 200 in a configuration which makes optimum use of the available space, for example with no wasted storage space above or in front of the appliances.

The invention is not limited to the specific embodiments described in detail above. Various modifications can be made to the details of the equipment shown in the attached figures without departing from the scope of the invention.

For instance, the upper surface 22 and /or the front surface 24 of at least one of the appliances 12, 14, 16 need not be flat. For example, the upper surface 22 of at least one of the appliances 12, 14, 16 may be shaped so when the appliances 12, 14, 16 are juxtaposed with contiguous side surfaces 20 on a horizontal support surface, only adjoining portions of the upper surfaces 22 of the appliances are substantially flush. By way of example, the upper surface 22 of the second appliance 14 may be curved or pitched in shape so that while the upper surfaces 22 of the appliances 12, 14, 16 are not co-planar, the flush adjoining portions of the upper surfaces 22 enable the appliances 12, 14, 16 to be quickly and easily wiped clean. Alternatively, or additionally, the front surface 24 of at least one of the appliances 12, 14, 16 may be shaped so when the appliances 12, 14, 16 are juxtaposed with contiguous side surfaces 20 on a horizontal support surface, only adjoining portions of the front surfaces 24 of the appliances are substantially flush.

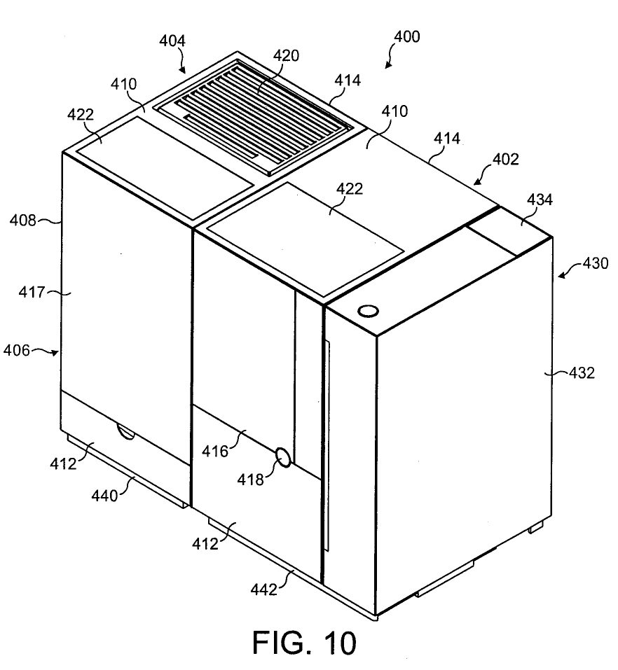

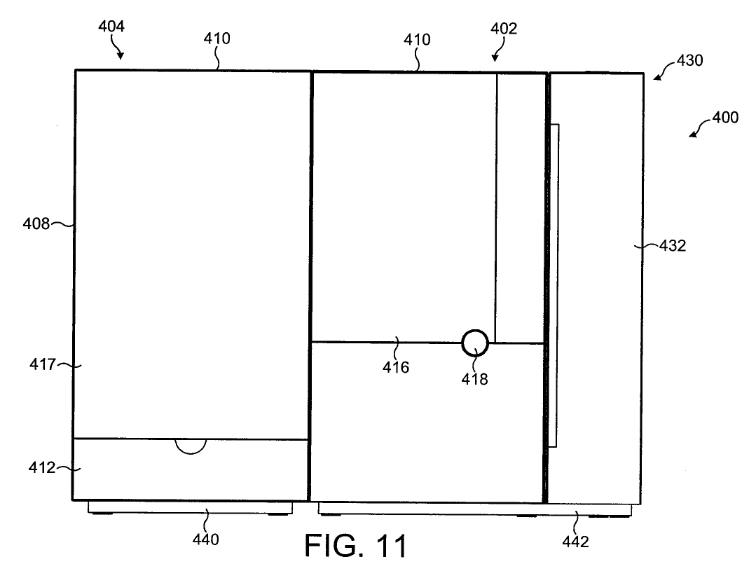

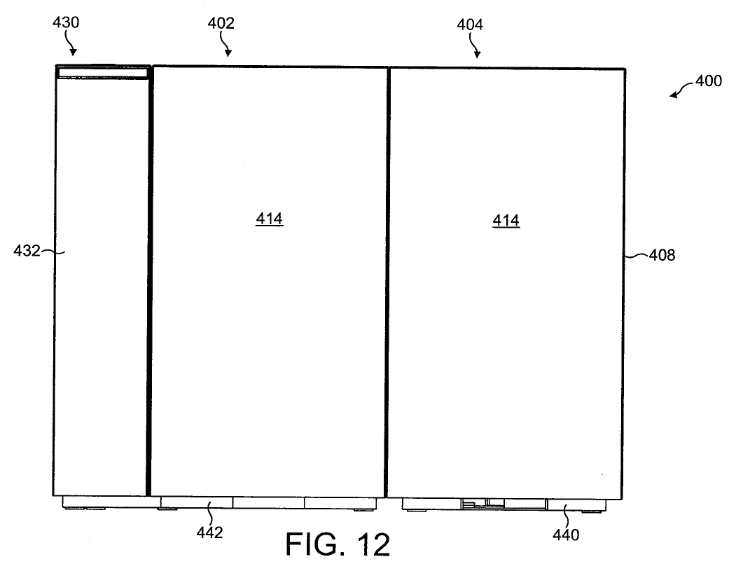

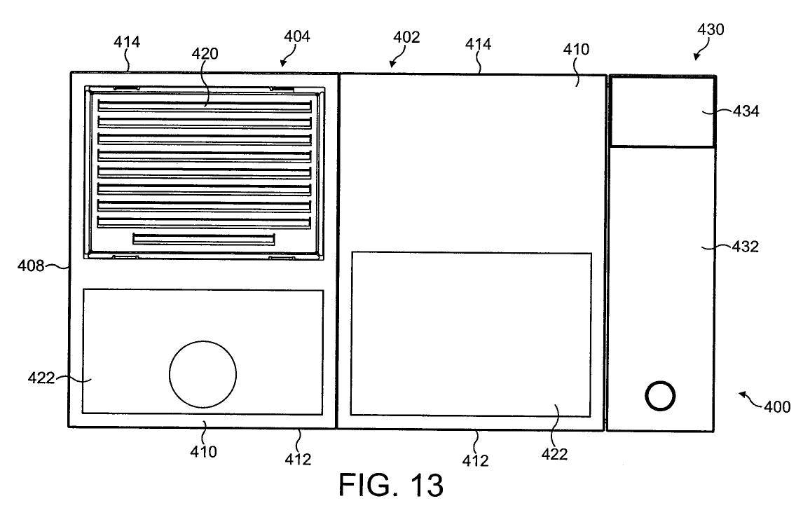

The base of one of the appliances may be arranged to receive the water tank. FIGS. 10 to 13 illustrate a second example of domestic equipment 400 according to the invention. Similar to the equipment 10, the equipment 400 may comprise any number of two or more appliances and in the illustrated example the equipment 400 comprises two appliances 402, 404. The first appliance 402 is a beverage dispenser and the second appliance 404 is a toaster. Each of the appliances 402, 404 comprises an outer housing 406 generally in the shape of the cuboid. The edges between the adjoining surfaces of each housing 406 are chamfered, with the radius of each chamfer being in the range from 0.5 to 5 mm.

Each housing 406 has two side surfaces 408 and, extending between the side surfaces 408, an upper surface 410, a front surface 412, a rear surface 414 and a lower surface (not shown). In this second example, each of the upper, front and rear surfaces 410, 412, 414 is substantially flat. As with the first example, one or more of the surfaces of the housing 406 may comprise a door or a lid which is moveable between a closed position, in which it is flush with the remainder of that surface, and an open position in which a user may access internal components of the appliance. For example, the first appliance 402 includes a drawer 416 slidably mounted in its front surface 412 for allowing a user to introduce ingredients to the first appliance 402, and the second appliance 404 has a hinged door 417 for allowing a user to introduce products to be toasted to the second appliance 404. The front surface 412 of the first appliance 402 also includes an aperture 418 through which a retractable dispensing spout may selectively extend, and the upper surface 410 of the second appliance 404 includes an array of apertures 420 through which steam and/or heat may be emitted from the housing 406 during use. A control panel 422 for controlling the operation of the appliance 402, 404 is located in a recessed portion of the upper surface 410 of each housing 406. To maintain the flatness of the upper surface 410 of the housing 406, the control panel 422 is sized and shaped to fit in the recessed portion of the upper surface 410 so the upper surface of the control panel 422 is substantially flush with the upper surface 410 of the housing 406.

As in the first example, the housings 406 of the appliances 402, 404 are substantially of the same height and same depth, and have similar dimensions to the housings 18 of the appliances 12, 14, 16 of the equipment 10. As illustrated in FIGS. 10 to 13, shaping the housings 406 of the appliances 402, 404 in this manner enables the equipment 400 to be arranged in a row on a work counter with contiguous side surfaces 408 and with no wasted counter space between, in front of or behind the appliances 402, 404. The common shape of the housings 408 also enables the appliances 402, 404 to be arranged in a row on a work counter with not only substantially flush upper surfaces 410, but also with substantially flush front surfaces 412 and substantially flush rear surfaces 414, allowing a user to quickly and easily wipe clean these surfaces.

The equipment 400 includes a water tank 430 for supplying water to the first appliance 402. The water tank 100 has an outer housing 432 substantially of the same height and depth as the housings 408 of the appliances 402, 404, but with a narrower width. The upper surface of the housing 432 comprises a lid 434 for closing an aperture through which the water tank is filled with water, the upper surface of the lid 434 being flush with the remainder of the upper surface of the housing 432.

Each appliance 402, 404 comprises a respective base 440, 442 in the form of a rectangular plate connected to the lower surface of the housing 408, and of similar thickness and configuration to the bases 50 of the equipment 10. In this second example, the base 440 of the first appliance 402 is wider than the base 442 of the second appliance 404 to enable the water tank 430 to be located on the base 442 alongside the first appliance 402 so that the front, upper and rear surfaces of the water tank 430 are flush with the corresponding surfaces 410, 412, 414 of the appliances 402, 404.

1. A domestic equipment group, comprising:
a plurality of free standing domestic electrical appliances, at least two of said appliances being for the preparation of foodstuffs,
each appliance having a different respective function and comprising an outer housing generally in the shape of a cuboid having two side surfaces and flat upper, front, and rear surfaces each extending between the side surfaces,
the housings being substantially of equal height and equal depth.

2. The domestic equipment group of claim 1, wherein each housing comprises a control panel for controlling the operation of the appliance.

3. The domestic equipment group of claim 2, wherein the control panel is located in a recessed portion of the upper surface of the housing, the control panel having an upper surface which is substantially flush with the upper surface of the housing.

4. The domestic equipment group of claim 3, wherein the control panel is located towards the front surface of the housing.

5. The domestic equipment group of claim 2, wherein the control panel is located on the housing so that, when the appliances are juxtaposed with substantially flush front surfaces, the control panels of the appliances are aligned.

6. The domestic equipment group of claim 1, wherein edges between adjoining surfaces of each housing are chamfered, each chamfer having a radius of less than 5 mm.

7. The domestic equipment group of claim 1, wherein at least two of the appliances have housings of substantially the same width.

8. The domestic equipment group of claim 1, wherein the appliances are juxtaposed and connected together so that the front surfaces of the housings are substantially flush.

9. The domestic equipment group of claim 1, wherein each appliance comprises a base connected to the lower surface of the housing.

10. The domestic equipment group of claim 9, wherein the base comprises a connector for connecting the appliance to one of the other appliances so that the front surfaces of the housings of those appliances are substantially flush.

11. The domestic equipment group of claim 10, wherein the connector is moveable between a stowed position and a deployed position in which it is connectable to the base of one of the other appliances.

12. The domestic equipment group of claim 11, wherein the base comprises a retainer for retaining a deployed connector of one of the other appliances.

13. The domestic equipment group of claim 12, wherein the retainer comprises a profiled portion of the base which is shaped to receive a deployed connector of one of the other appliances.

14. The domestic equipment group of claim 9, wherein the base is configured to receive and store at least part of a mains cable extending from the lower surface of the housing.

15. The domestic equipment group of claim 14, wherein the base has a lower surface shaped to define a channel for receiving and storing the cable.

16. The domestic equipment group of claim 15, wherein the channel comprises at least one opening located on the peripheral surface of the base, a first portion for retaining a length of the cable, and a second portion extending between the first portion and said at least one opening.

17. The domestic equipment group of claim 16, wherein the first portion of the channel extends about a hub around which the cable may be wound.

18. The domestic equipment group of claim 16, wherein the channel has a plurality of openings located about the periphery of the base, and wherein the second portion of the channel is shaped to guide the cable from the first portion of the channel to a selected opening.

19. The domestic equipment group of claim 18, wherein the openings are located about the bases of the appliances so that, when the appliances are juxtaposed with contiguous side surfaces on a horizontal support surface with substantially flush front surfaces, an opening of the base of one of the appliances is aligned with an opening of the base of one of the other appliances.

20. The domestic equipment group of claim 18, wherein the openings are located about the bases of the appliances so that, when two of the appliances are juxtaposed with contiguous rear surfaces on a horizontal support surface with substantially flush side surfaces, an opening of the base of one of the appliances is aligned with an opening of the base of the other appliance.

21. The domestic equipment group of claim 15, wherein the channel is shaped to enable part of a mains cable of another electrical appliance to be located therein.

22. The domestic equipment group of claim 1, wherein the appliances are portable.

23. The domestic equipment group of claim 1, wherein at least one of the appliances has a function which is other than for the preparation of foodstuffs.

24. The domestic equipment group of claim 23, wherein said at least one of the appliances comprises an audio/visual appliance, a television, a display screen, a radio, a DVD player or a CD player, a clock, a loudspeaker, a steriliser or a drinks cooler.

25. The domestic equipment group of claim 1, comprising a water tank supplying water to at least one of the appliances, wherein the water tank comprises an outer housing substantially of the same height and depth as the housings of the appliances.

26. The domestic equipment group of claim 1, wherein said appliances comprise at least two of a juice extractor, a toaster, a beverage maker, a hot water dispenser, a kettle and a coffee grinder.
